(19) United States
(12) Patent Application Publication
(10) Pub. No.: US 2021/0229834 A1
(43) Pub. Date: Jul. 29, 2021

(54) GUIDANCE OF UNMANNED AERIAL INSPECTION VEHICLES IN WORK ENVIRONMENTS USING OPTICAL TAGS

(71) Applicant: 3M INNOVATIVE PROPERTIES COMPANY, St. Paul, MN (US)

(72) Inventors: James W. Howard, North Oaks, MN (US); James L.C. Werness, Jr., Edina, MN (US); Caroline M. Ylitalo, Stillwater, MN (US); Claire R. Donoghue, Reading (GB); John A. Wheatley, Stillwater, MN (US); Robert D. Lorentz, North Oaks, MN (US); Tien Yi T.H. Whiting, St. Paul, MN (US); Matthew E. Sousa, Rosemount, MN (US); Carla H. Barnes, St. Paul, MN (US)

(21) Appl. No.: 17/250,044

(22) PCT Filed: May 8, 2019
(86) PCT No.: PCT/IB2019/053780

§ 371 Date: Nov. 12, 2020

Related U.S. Application Data
(60) Provisional application No. 62/671,042, filed on May 14, 2018.

(51) Int. Cl. B64F 1/20; G05D 1/10; G05D 1/06; G06T 7/73; B64D 47/08

(52) U.S. Cl. CPC B64F 1/20; G05D 1/101; B64C 2201/14; G06T 7/73; B64D 47/08; G05D 1/0676

(57) ABSTRACT

The systems and techniques of this disclosure relate to improving work safety in confined spaces by, for example, using machine vision to analyze location marking labels in the confined space to control an unmanned aerial vehicle (UAV) within the confined space. In one example, a system includes a UAV that includes an imaging device and a processor communicatively coupled to the imaging device. The processor may be configured to receive, from the imaging device, an image of a confined space, detect a location marking label within the image, process the image to decode data embedded on the location marking label, and control navigation of the UAV within the confined space based on the data decoded from the location marking label.

### TECHNICAL FIELD

The present disclosure relates to work safety equipment and, more specifically, to work safety equipment used for inspection and maintenance of confined work environments.

### BACKGROUND

Some work environments, such as, for example, confined spaces, include areas with limited or restricted ingress or egress that are not designed for continuous occupancy. Work in confined work environments is typically regulated by the owner and/or operator of the confined work environments. Example confined work environments include, but are not limited to, manufacturing plants, coal mines, larger tanks, vessels, silos, storage bins, hoppers, vaults, pits, manholes, tunnels, equipment housings, ductwork, and pipelines.

In some situations, a confined space entry by one or more workers (e.g., entrants) may present inherent health or safety risks associated with a confined space, such as potential exposure to a hazardous atmosphere or material that may injure or kill entrants, material within the confined space that has the potential to trap or even engulf an entrant, walls or floors that have shifted or converge into a smaller area that may trap or asphyxiate an entrant, unguarded machinery or potential stored energy (e.g., electrical, mechanical, or thermal) within equipment. Moreover, the occurrence of a safety event, e.g., outbreak of a fire or chemical spill within the confined space, may further put the entrant at risk. To help ensure safety of entrants, confined space entry procedures may include lockout-tagout of pipes, electrical lines, and moving parts associated with the confined space, purging the environment of the confined space, testing the atmosphere at or near entrances of the confined space, and monitoring of the confined space entry by an attendant (e.g., a worker designated as hole-watch).

### SUMMARY

The systems and techniques of this disclosure relate to improving work safety in work environments, such as confined spaces, by using machine vision to analyze location marking labels in a work environment to control an unmanned aerial vehicle (UAV) within the work environment. Although techniques of this disclosure are described with respect to confined spaces for example purposes, the techniques may be applied to any designated or defined region of a work environment. In some examples, the designated or defined region of the work environment may be delineated using geofencing, beacons, optical fiducials, RFID tags, or any other suitable technology for delineating a region or boundary of a work environment.

In some examples, an imaging device is mounted on a UAV to capture one or more images of a location marking label in a confined space. A processor communicatively coupled to the imaging device is configured to receive the one or more images of the location marking label. The processor also is configured to process the one or more images to decode data embedded on the location marking label. For example, the decodable data may include a location of the location marking label in the confined space or a command readable by the processor. Based on the data decoded from the location making label, the processor is configured to control the UAV. For example, the processor may control navigation of the UAV or command the UAV to perform a task, such as observing hazards (e.g., gas monitoring) in the confined space or performing work in the confined space. In some examples, the imaging device may further capture one or more images of an entrant, e.g., in a man-down situation, and the processor may determine an approximate location of the entrant and/or observe hazards near the entrant, e.g., to relay to a rescue response team. In this way, the disclosed systems and techniques may improve work safety in confined spaces by enabling a UAV to navigate through confined space to observe hazards in the confined space and/or perform work in the confined space. By observing hazards in the confined space and/or performing work in the confined space, the disclosed systems and techniques may reduce the number of entrants required for a confined space entry or entry-required rescue and/or reduce the duration of a confined space entry or entry-required rescue response time, thereby reducing entrant exposure to potential hazards in the confined space.

In some examples, the disclosure describes a system including a UAV that includes an imaging device and a processor communicatively coupled to the imaging device. The processor may be configured to receive, from the imaging device, an image of a confined space, detect a location marking label within the image, process the image to decode data embedded on the location marking label, and control navigation of the UAV within the confined space based on the data decoded from the location marking label.

In some examples, the disclosure describes a system including a confined space entry device that includes an imaging device and a processor communicatively coupled to the imaging device. The processor may be configured to receive, from the imaging device, an image of a confined space, detect a location marking label within the image, process the image to decode data embedded within the location marking label, and control navigation of the confined space entry device within the confined space based on the data decoded from the location marking label.

In some examples, the disclosure describes a method including deploying, into a confined space, an unmanned aerial vehicle (UAV), the UAV including an imaging device. The method also includes receiving, by a processor communicatively coupled to the imaging device, an image of the confined space captured by the imaging device. The method also includes detecting a location marking label within the image. The method also includes processing, by the processor, the image to decode data embedded on the location marking label. The method also includes controlling, by the processor, navigation of the UAV within the confined space based on the data decoded from the location marking label.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is a schematic and conceptual block diagram illustrating an example system that includes a UAV having an imaging device mounted thereon to capture an image of a location marking label in a confined space and a computing device communicatively coupled to the imaging device.

FIGS. 2A and 2B are schematic and conceptual diagrams illustrating an example UAV having an imaging device and a computing device mounted thereon.

FIG. 3 is a schematic and conceptual block diagram illustrating an example confined space entry device that includes an imaging device and a computing device.

FIG. 4 is a schematic and conceptual diagram illustrating an example location marking label including decodable data for embodiment within a confined space.

FIGS. 5A and 5B are schematic and conceptual diagrams illustrating a portion of an example location marking label.

FIG. 6 is a flowchart illustrating an example of controlling a UAV based on data decoded from a location marking label.

The details of one or more examples of this disclosure are set forth in the accompanying drawings and the description below. It is to be understood that the examples may be used and/or structural changes may be made without departing from the scope of the invention. Other features, objects, and advantages of this disclosure will be apparent from the description and drawings, and from the claims.

### DETAILED DESCRIPTION

The systems and techniques of this disclosure relate to improving work safety in work environments by using machine vision to analyze location marking labels in a work environment to control a work environment analysis device, such as an unmanned aerial vehicle (UAV), within the work environment. Although techniques of this disclosure are described with respect to confined space work environments for example purposes, the techniques may be applied to any designated or defined region of a work environment. For example, the designated or defined region of the work environment may be delineated by physical boundaries, such as a confined space vessel, or using, for example, geofencing, beacons, optical fiducials, RFID tags, or any other suitable technology for delineating a region or boundary of a work environment.

In some examples, an imaging device is mounted on a UAV and configured to capture one or more images of a confined space. In other examples, the imaging device may be mounted on a different vehicle or a device wearable by an entrant or attendant. A processor communicatively coupled to the imaging device is configured to receive the one or more images of the confined space. The processor may be mounted on-board the UAV (or other vehicle or wearable device), such that the imaging device and processor are components of the same confined space entry device, or remotely-located from the confined space entry device (e.g., a remote server or control station). The processor also is configured to detect a location marking label within the received image and process the one or more images to decode data embedded on the location marking label. For example, the data may include a location of the location marking label in the confined space or a command readable by the processor. Based on the data decoded from the location making label, the processor is configured to control the UAV. For example, the processor may control navigation of the UAV or command the UAV to perform a task, such as observing hazards in the confined space (e.g., gas monitoring) or performing work in the confined space. In this way, the disclosed systems and techniques may improve work safety in confined spaces by enabling a UAV to navigate through confined space to observe hazards in the confined space and/or perform work in the confined space. By observing hazards in the confined space and/or performing work in the confined space, the disclosed systems and techniques may reduce the number of entrants required for a confined space entry or entry-required rescue and/or reduce the duration of a confined space entry or entry-required rescue response time, thereby reducing entrant exposure to potential hazards in the confined space.

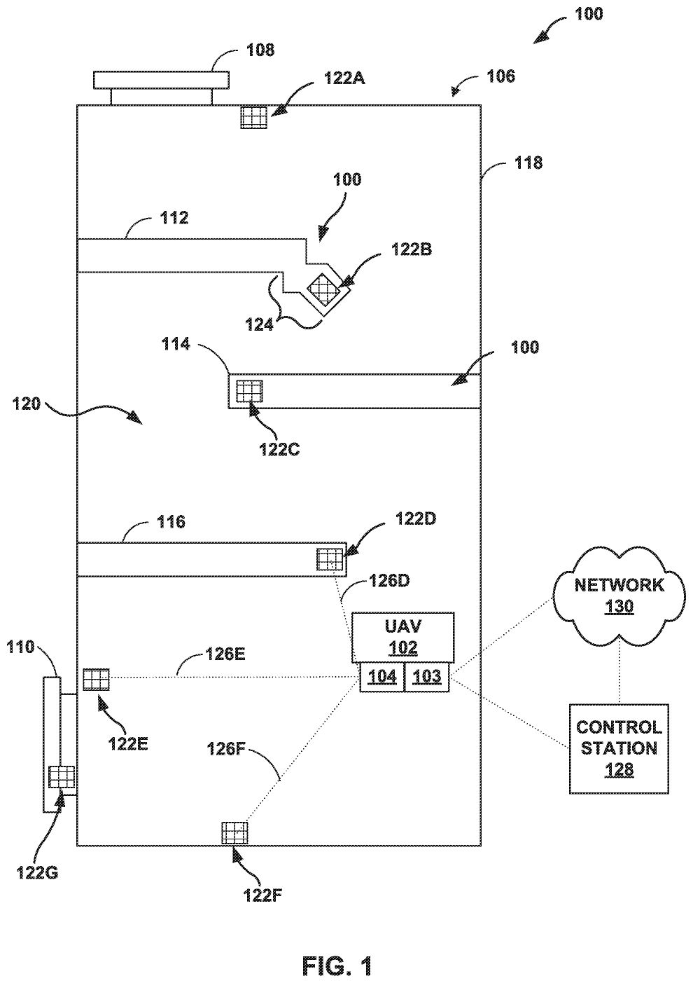

FIG. 1 is a schematic and conceptual block diagram illustrating an example system 100 that includes an unmanned aerial vehicle (UAV) 102 having an imaging device 104 mounted thereon to capture an image of a location marking label in a confined space 106 and a computing device 103 communicatively coupled to imaging device 104. Imaging device 104 may be mounted on UAV 102 in any suitable manner, such as a fix or movable arm. Computing device 103 may be mounted on UAV 102 or remotely-located, and configured to autonomously control operation of UAV 102, such as, for example, navigation of UAV 102 in confined space 106 and/or control an operation of system 100, such as, for example, monitoring the local environment within confined space 106, operating a light source, operating an audible device, operating a device to discharge a gas or liquid, or the like.

Confined space 106 includes a confined work environment, such as areas with limited or restricted ingress or egress and not designed for continuous occupancy by humans. Confined space 106 has particularized boundaries delineating a volume, region, or area defined by physical characteristics. For example, confined space 106 may include a column having manholes 108 and 110, trays 112, 114, and 116, and circumferential wall 118. In other examples, confined space 106 may include, but is not limited to, a manufacturing plant, a coal mine, a tank, a vessel, a silo, a storage bin, a hopper, a vault, a pit, a manhole, a tunnel, an equipment housing, a ductwork, and a pipeline. In some examples, confined space 106 includes internal structures, such as agitators, baffles, ladders, manways, passageways, or any other physical delineations. The particularized boundaries and internal structures define the interior space 120 of confined space 106. In some examples, confined space 106 may hold liquids, gases, or other substances that may be hazardous to the health or safety of an entrant, e.g., pose a risk of asphyxiation, toxicity, engulfment, or other injury. Confined space 106 may require specialized ventilation and evacuation systems for facilitating a temporarily habitable work environment, e.g., for a confined space entry. Although described with respect to confined space 106, the systems and techniques of the disclosure may be applied to any designated or defined region of a work environment. For example, the designated or defined region of the work environment may be delineated using, for example, geofencing, beacons, optical fiducials, RFID tags, or any other suitable technology for delineating a region or boundary of a work environment.

As shown in FIG. 1, system 100 includes UAV 102, computing device 103, and imagine device 104. The term “unmanned aerial vehicle” and the acronym “UAV” refers to any vehicle that can perform controlled aerial flight maneuvers without a human pilot physically on board (such vehicles may be referred to as “drones”). UAV may be remotely guided by a human operator, autonomous, or semi-autonomous. For example, UAV 102 may be flown to a destination while under remote control by a human operator, with autonomous control taking over, e.g., when remote control communication to UAV 102 is lost, to perform fine movements of the UAV as may be needed to navigate interior 120 of confined space 106, and/or during portions of a flight path such as take-off or landing. While FIG. 1 illustrates system 100 including UAV 102, in some examples, system 100 may include other piloted or autonomous aerial, terrestrial, or marine vehicles, or wearable devices.

UAV 102 is configured to enter confined space 106. For example, UAV 102 may be designed to fit within interior space 120, such as, for example, through manholes 108 or 110 and between wall 118 and trays 112, 114, or 116. In examples in which confined space 106 holds a particular liquid or gas, UAV 102 may be designed to operate in environments having the particular liquid or gas, such as, for example, in environments containing flammable and/or corrosive liquids and/or gases.

Confined space 106 includes one or more location marking labels 122A, 122B, 122C, 122D, 122E, 122F, and 122G (collectively, “location marking labels 122”). Location marking labels 122 may be located on an interior surface or an exterior surface of confined space 106. Each respective location marking label of location marking labels 122 is associated with a respective location in confined space 106. Each respective location marking label of location marking labels 122 includes at least one respective optical pattern embodied therein. The at least one optical pattern includes a machine-readable code (e.g., decodable data). In some examples, location marking labels 122, e.g., optical pattern embodied thereon, may be a retroreflective material layer. In some examples, the machine-readable code may be printed with infrared absorbing ink to enable an infrared camera to obtain images that can be readily processed to identify the machine-readable code. In some examples, location marking labels 122 include an adhesive layer for adhering location marking labels to a surface of confined space 106. In some examples, location marking labels 122 include an additional mirror film layer that is laminated over the machine-readable code. The mirror film may be infrared transparent such that the machine-readable code is not visible in ambient light but readily detectable within images obtained by an infrared camera (e.g., with some instances of imaging device 104). Additional description of a mirror film is found in PCT Appl. No. PCT/US2017/014031, filed Jan. 19, 2017, which is incorporated by reference herein in its entirety. The machine-readable code is unique to a respective location marking label of location marking labels 122, e.g., a unique identifier, unique location data, and/or unique command data. In this way, system 100 may use the machine-readable code to identify a location of UAV 102 inside confined space 106 or command system 100 to perform an operation.

Location marking labels 122 are embodied on a surface of confined space 106 to be visible such that imaging device 104 may obtain images of the location marking labels 122 when UAV 102 is inside confined space 106. Location marking labels may be any suitable size and shape. In some examples, of location marking labels 122 include rectangular shape that are between approximately 1 centimeter by 1 centimeter to approximately 1 meter by 1 meter, such as approximately 15 centimeters by 15 centimeters. In some examples, each location marking label of location marking labels 122 may be embodied on a label or tag affixed to a variety of types surfaces of interior 120 of confined space 106, such as, for example, floors, walls (e.g., wall 118), ceilings, or other internal structures (e.g., trays 112, 114, or 116), using an adhesive, clip, or other fastening means to be substantially immobile with respect to interior 120 of confined space 106. In such examples, location marking labels 122 may be referred to as “optical tags” or “optical labels.” By affixing to a surface of interior 120 of confined space 106, location marking labels 122 may be associate with a specific location within confined space 106.

In some examples, a respective location marking label of location marking labels 122 may be embodied on a label or tag affixed to a variety of types of or exterior surfaces of confined space 106. By affixing to an exterior surface of confined space 106, location marking labels 122 (e.g., location marking label 122G) may be associated with a specific exterior feature of confined space 106, such as manhole 110 or other ingress to confined space 106.

In some examples, confined space 106 is manufactured with location marking labels 122 embodied thereon. In some examples, location marking labels 122 may be printed, stamped, engraved, or otherwise embodied directly on a surface of interior 120 of confined space 106. In some examples, location marking labels 122 may include a protective material layer, such as a thermal or chemical resistant film. In some examples, a mix of types of embodiments of location marking labels 122 may be present in confined space 106. For example, a respective location marking label of location marking labels 122 may be printed on a surface of interior 120 of confined space 106, while a second respective location marking label of location marking labels 122 is printed on a label affixed to a surface of interior 120 of confined space 106. In this way, location marking labels 122 may be configured to withstand conditions within confined space 106 during operation of the confined space, such as, for example, non-ambient temperatures, pressures, and/or pH, fluid and/or material flow, presence of solvents or corrosive chemicals, or the like.

Each respective location marking label of location marking labels 122 may have a relative spatial relation with respect to each different location marking label of location marking labels 122. The relative spatial relation of location marking labels may be recorded in a repository of system 100 configured to store a model of confined space 106. The model may include a location of each respective location marking label of location marking labels 122 within confined space 106. For example, location marking labels 122D is a specific distance and trajectory from location marking labels 122E and 122F. In some examples, imaging device 104 may view each of 122D and 122E and/or 122F from a location of UAV 102 within confined space 106. By viewing each of 122D and 122E and/or 122F system 100 may determine the relative location of UAV 102 within confined space 106. In some examples, an anomaly in the relative spatial relation (e.g., an altered or displaced relative spatial relation) with respect to location marking labels 122 may indicate damage to interior 120 of confined space 106. For example, by viewing each of 122B and 122A and/or 122C system 100 may determine that location marking label 122B is displaced, e.g., that portion 124 of tray 112 is displaced or otherwise damaged such that location marking label 122B is displaced from a location of location marking label 122B in the model. In this way, system 100 may determine a relative location of UAV 102 within confined space 106 and/or determine a condition present in confined space 106 such as a displaced surface of interior 120 of confined space 106. By determining a relative location of UAV within confined space 106 and/or determining a condition present in confined space 106, system 100 may determine a path of travel of UAV 102 (e.g., at least one distance vector and at least one trajectory) to a second location within confined space 106 or that repair to interior 120 is required. In this way, system 100 may control navigation of UAV 102 within confined space 106 based on the data decoded from a respective location marking label of location marking labels 122.

Imaging device 104 obtains and stores, at least temporarily, images 126D, 126E, and 126F (collectively, “images 126”) of interior 120 of confined space 106. Each respective image of images 126 may include a respective location marking label of location marking labels 122. In some examples, computing device 103 communicatively coupled to imaging device 104, receives images 126 from imaging device 104 in near real-time for near real-time processing. Imaging device 104 may receive multiple images 126 at a frequency at a position and orientation of imaging device 104. For instance, imaging device 104 may receive an instance of images 126 once every second.

Imaging device 104 may be an optical camera, video camera, infrared or other non-human-visible spectrum camera, or a combination thereof. Imaging device 104 may be a mounted by a fixed mount or an actuatable mount, e.g., moveable along one or more degrees of freedom, on UAV 102. Imaging device 104 includes a wired or wireless communication link with computing device 103. For instance, imaging device 104 may transmit images 126 to computing device 103 or to a storage system communicatively coupled to computing device 103 (not shown in FIG. 1). Alternatively, computing device 103 may read images 126 from a storage device for imaging device 104, or from the storage system communicatively coupled to computing device 103. Although only a single imaging device 104 is depicted, UAV 102 may include multiple imaging devices 104 positioned about UAV 102 and oriented in different orientations to capture images of confined space 106 from different positions and orientations, such that images 126 provide a more comprehensive view of interior 120 of confined space 106. As described herein, images 126 may refer to images generated by multiple imaging devices 104. In some examples, the multiple imaging devices 104 have known spatial inter-relations among them to permit determination of spatial relations between location marking labels 122 in respective images of images 126 generated by a respective imaging device of multiple imaging devices 104.

Computing device 103 includes a processor to processes one or more images of images 126 to decode data embedded on location marking labels 122. Computing device 103 may detect a respective location marking label of location marking labels 122 within a respective image of images 126. In some examples, computing device 103 may detect location marking labels 122 based at least in part on a general boundary, optical pattern, color, reflectivity (e.g., reflectively of a selected wave length of radiation, such as infrared radiation), or the like of location marking labels 122. Computing device 103 also may process one or more images of images 126 to identify the machine-readable codes of the location marking labels 122. For example, in examples in which confined space 106 holds a material hazardous to UAV 102 (e.g., dust, liquids, or gas that may damage UAV 102), a respective location marking label of location marking labels 122 (e.g., location marking label 122G) may enable UAV 102 to determine that UAV 102 should not enter confined space 106. Additionally, or alternatively, a processor of computing device 103 may process one or more images of images 126 to determine a spatial relation between one or more location marking labels 122 and UAV 102. To determine the spatial relation between one or more location marking labels 122 and UAV 102, computing device 103 may determine, from one or more images of images 126 and, optionally, a model of location marking labels 122 within confined space 106, a position of each respective location marking label of the one or more location marking labels 122 and/or an orientation of each respective location marking label of the one or more location marking labels 122 with respect to a coordinate system relative to UAV 102.

For example, computing device 103 may process one image of images 126 to determine the spatial relation between a respective location marking label of location marking labels 122, such as a distance of UAV 102 from the respective location marking label of location marking labels 122 and/or an orientation of UAV 102 relative to the respective location marking label of location marking labels 122. The spatial relation may indicate that UAV 102 (or imaging device 104) is a distance from a respective location marking label of location marking labels 122, e.g., 3 meters. The spatial relation may indicate UAV 102 (or imaging device 104) has a relative orientation to a respective location marking label of location marking labels 122, e.g., 90 degrees. The spatial relation may indicate a different respective location marking label of location marking labels is located a distance and direction vector from a current location of UAV 102 (e.g., UAV 102 may locate a second respective location marking label of location marking labels 122 based on the spatial relation between a first respective location marking label of location marking labels 122.

In some examples, computing device 103 may process at least one image of images 126 to determine the distance of UAV 102 from the respective location marking label of location marking labels 122 by determining a resolution of the respective location marking label of location marking labels 122 in the one image of images 126. For example, a first resolution of the respective location marking label of location marking labels 122 may include decodable data indicating that imaging device 104 is a first distance from the respective location marking label of location marking labels 122 during acquisition of a first image of images 126. Similarly, a second resolution of the respective location marking label of location marking labels 122 may include second decodable data indicating that imaging device 104 is a second distance from the respective location marking label of location marking labels 122 during acquisition of a second image of images 126.

Additionally, or alternatively, computing device 103 may process at least one image of images 126 to determine an orientation of UAV 102 (e.g., based on a known orientation of imaging device 104 relative to UAV 102) relative to the respective location marking label of location marking labels 122. For example, a respective location marking label of location marking labels 122 may include decodable data indicating an orientation of the respective location marking label of location marking labels 122 relative to confined space 106, e.g., the at least one image of images 126 may indicate an orientation of a coordinate system relative to interior 120 of confined space 106. In this way, computing device 103 may determine a location and/or an orientation of UAV 102 within confined space 106 based on data decoded from at least one image of images 126 of at least one location marking label of location marking labels 122.

Additionally, or alternatively, computing device 103 may process at least one image of images 126 to determine an orientation of a respective location marking label of location marking labels 122 relative to confined space 106 (e.g., based on a known orientation of imaging device 104 relative to UAV 102 or relative to other location marking labels of location marking labels 122 having a known orientation). For example, a respective location marking label of location marking labels 122 may include decodable data indicating an orientation of the respective location marking label of location marking labels 122. Computing device 103 may associate an orientation of UAV 102 (e.g., based on a known orientation of imaging device 104 relative to UAV 102 or relative to other location marking labels of location marking labels 122 having a known orientation) with the determined orientation of the respective location marking label of location marking labels 122 to determine an orientation of the respective location marking label of location marking labels 122 relative to confined space 106. In this way, computing device 103 may determine a location and/or an orientation of a respective location marking label of location marking labels 122 within confined space 106 based on data decoded from at least one image of images 126 of the respective location marking label of location marking labels 122.

Additionally or alternatively, computing device 103 may use one or more algorithms, such as simultaneous localization and mapping (SLAM) algorithms, to process at least one image of images 126 to determine the spatial relation between at least one respective location marking label of location marking labels 122, such as a distance of UAV 102 from at least one respective location marking label of location marking labels 122 and/or an orientation of UAV 102 relative to at least one respective location marking label of location marking labels 122. Identifiable key points in SLAM processing may include at least one respective location marking label of location marking labels 122. Computing device 103 may determine, e.g., by SLAM processing, a three-dimensional point cloud or mesh including a model of confined space 106 based on at least one respective location marking label of location marking labels 122. Computing device 103 may be configured to record in a repository of system 100 the three-dimensional point cloud or mesh as a model of confined space 106. The three-dimensional point cloud or mesh may provide a relatively higher definition model of confined space 106 that may be used by computing device 103 to improve an ability of computing device 103 to process relatively lower resolution images 126. For example, in example in which images 126 include relatively lower resolution images 126 (e.g., images obtained in conditions, such as smoke, debris, or low light, inside confined space 106 that obscure or otherwise reduce the resolution of the images), computing device 103 may use the three-dimensional point cloud or mesh determined by SLAM processing to improve the usability of the relatively lower resolution images (e.g., by registering at least a portion of the relatively lower resolution images 126 to the relatively higher resolution three-dimensional point cloud or mesh).

Additionally, or alternatively, system 100 may include an environmental sensor communicatively coupled to a computing device 103 and mounted on UAV 102. The environmental sensor may include, but is not limited to, a multi-gas detector for testing flammable gases lower explosive limit (LEL), toxic gases (e.g., hydrogen sulfate, carbon monoxide, etc.), and/or oxygen levels (e.g., oxygen depletion), a temperature sensor, a pressure sensor, or the like. Computing device 103 may, based on a command decoded from at least one image of images 126, cause the environmental sensor to collect environmental information in confined space 106. In this way, computing device 103 may determine an environmental condition, such as presence of harmful gases, dangerously low or high oxygen levels, or hazardous temperature or pressure, within confined space 106.

As another example, computing device 103 may process a plurality of images 126 (e.g., two or more images of images 126) to determine the spatial relation between a plurality of location marking labels 122 (e.g., two or more location marking labels of location marking labels 122). For example, computing device 103 may process images 126D, 126E, and 126F of, respectively, location marking labels 122D, 122E, and 122F to determine a location and/or orientation of UAV 102 within confined space 106. In some examples, computing device 103 may process each respective image (e.g., images 126D, 126E, and 126F), as discussed above, to determine and compare locations and/or orientations of UAV 102 relative the respective location marking label (e.g., location marking labels 122D, 122E, and 122F). For example, computing device 103 may use a plurality of distances of UAV 102 from location marking labels 122D, 122E, and 122F determined from images 126D, 126E, and 126F to triangulate the location of UAV 102 within confined space 106. In this way, computing device 103 may determine a location and/or an orientation of UAV 102 within confined space 106 based on data decoded from a plurality of images 126 of a plurality of location marking labels 122. Using a plurality of images 126 of a plurality of location marking labels 122 may allow system 100 to more accurately determine a location and/or an orientation of UAV 102 within confined space 106.

In some examples, system 100 includes additional components, such as, for example, a remotely-located control station 128 communicatively coupled to computing device 103 and/or imaging device 104. For example, remotely-located control station 128 may be communicatively coupled to computing device 103 and/or imaging device 104 by any suitable wireless connection, including, for example, via a network 130, such as a local area network. Remotely-located control station 128 may include an interface operable by a user, such as a human operator or a machine.

In some examples, system 100 may be configured to respond to an entry-required rescue situation in confined space 106, e.g., when an entrant is disabled and unable to be retrieved by non-entry means. For example, UAV 102 may be deployed in confined space 106 to search for a disabled entrant. Imaging device 104 may be configured to capture images 126 of interior 120, as discussed above. Computing device 103 may obtain images 126 from imaging device 104 to determine if images 126 include the disabled entrant. For example, computing device 103 may include image recognition software to identify characteristics of optical images of the disabled entrant such as a shape of an entrant, an optical tag associated with (e.g., attached to PPE worn by) the disabled entrant, or an anomaly in interior 120 caused by the presence of the disabled entrant. As another example, computing device 103 may include image recognition software to identify infrared characteristics of the disabled entrant such as infrared radiation emitted by the disabled entrant. In some examples, system 100 may both determine a location of UAV 102 within confined space 106, as discussed above, and identify a man-down within confined space 106. For example, in response to identifying the disabled entrant, system 100 may then determine a location of UAV 102, as discussed above. In this way, computing device 103 may identify the disabled entrant and determine the approximate location of the disabled entrant within confined space 106. In response to identifying a man-down, system 100 may optionally determine an environmental condition within confined space 106. In some examples, system 100 may provide environmental condition information to a rescue response team, e.g., via a remotely-located control station 128, and/or determine whether environmental conditions allow for safe rescue of the disabled entrant. In this way, system 100 may reduce the number of entrants required for an entry-required rescue of the disabled entrant, reduce the duration of the entry-required rescue, and/or reduce exposure of rescuers to environmental conditions within confined space 106 that may injure potential rescuers.

Other examples involving other types of confined space 106, other internal structures within confined space 106, and/or local environmental conditions within confined space 106 are contemplated.

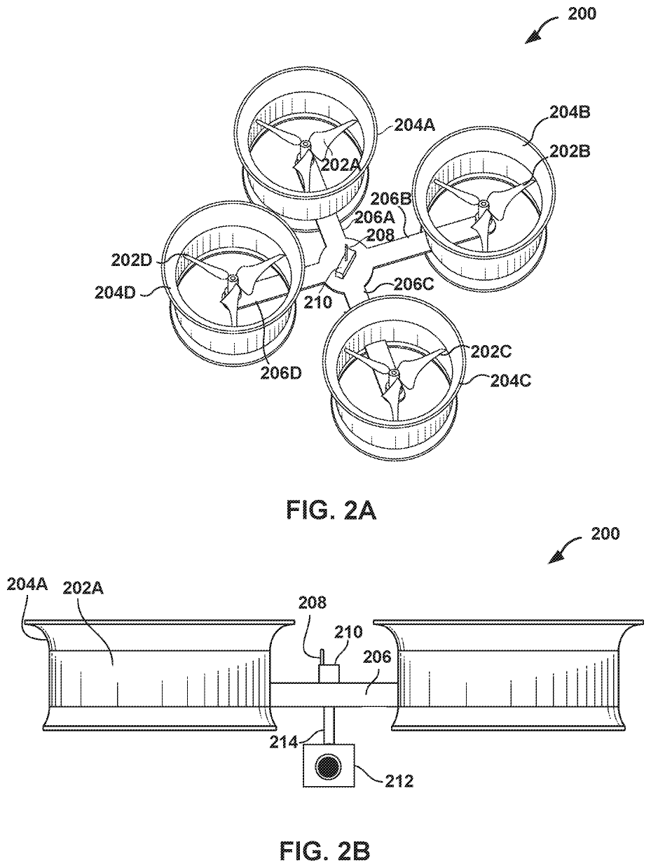

FIGS. 2A and 2B are schematic and conceptual diagrams illustrating an example UAV 200 having an imaging device 212 and a computing device 210 mounted thereon. The components of UAV 200 may be the same or substantially similar to the components of system 100 described above with respect to FIG. 1. For example, computing device 210 may be the same as or substantially similar to computing device 103 and imaging device 212 may be the same or substantially similar to imaging device 104.

UAV 200 is a rotorcraft, typically referred to as a multicopter. The example design shown in FIG. 2 includes four rotors 202A, 202B, 202C, and 202D (collectively, “rotors 202”). In other examples, UAV 200 may include fewer or more rotors 202 (e.g., two, three, five, six, and so on). Rotors 202 provide propulsion and maneuverability for UAV 200. Rotors 202 may be motor-driven; each rotor may be driven by a separate motor; or, a single motor may drive all of the rotors by way of e.g. drive shafts, belts, chains, or the like. Rotors 202 are configured so that UAV 200 is able to, for example, to take off and land vertically, maneuver in any direction, and hover. The pitch of the individual rotors and/or the pitch of individual blades of specific rotors may be variable in-flight so as to facilitate three-dimensional movement of UAV 200 and to control UAV 200 along the three flight control axes (pitch, roll and yaw). UAV 200 may include rotor protectors (e.g. shrouds) 204 to protect each rotor of rotors 202 from damage and/or protect nearby objects from being damaged by rotors 202. Rotor protectors 204, if present, can be of any suitable size and shape. Additionally, or alternatively, UAV 200 may include a cage (not shown) configured to surround all rotors 202. In some examples, UAV 200 may include landing gear (not shown) to assist with controlled and/or automated take-offs and landings.

UAV 200 includes one or more supporting struts 206A, 206B, 206C, and 206D (collectively, “supporting struts 206”) that connect each rotor of rotors 202 to at least one other rotor of rotors 202 (e.g. that connect each rotor/shroud assembly to at least one other rotor/shroud assembly). Supporting struts 206 provide overall structural rigidity to UAV 200.

UAV 200 includes computing device 210. Computing device 210 includes a power source for powering the UAV and a processor for controlling the operation of UAV 200. Computing device 210 may include additional components configured to operate UAV 200 such as, for example, communication units, data storage modules, gyroscopes, servos, and the like. Computing device 210 may be mounted on one or more supporting struts 206. In some examples, computing device 210 may include firmware and/or software that include a flight control system. The flight control system may generate flight control instructions. For example, flight control instructions may be sent to rotors 202 to control operation of rotors 202. In some examples, flight control instructions may be based on flight-control parameters autonomously calculated by computing device 210 (e.g., an on-board guidance system or an on-board homing system) and/or based at least partially on input received from a remotely-located control station. In some examples, computing device 210 may include an on-board autonomous navigation system (e.g. a GPS-based navigation system). In some examples, as discussed above with respect to FIG. 1, computing device 210 may be configured to autonomously guide itself within confined space 106 and/or can home in on a landing location, without any intervention by a human operator.

In some examples, UAV 200 may include one or more wireless transceivers 208. Wireless transceivers 208 may send and receive signals from a remotely-located control station, such as, for example, a remote controller operated by a user. Wireless transceiver 208 may be communicatively coupled to computing device 210 to, for example, rely signals from wireless transceiver 208 to computing device 210, and vice versa.

UAV 200 includes one or more imaging device 212. As discussed above, computing device 210 may receive images from imaging device 212. In some examples, imaging device 212 may wirelessly transmit real-time images (e.g. as a continuous or quasi-continuous video stream, or as a succession of still images) by transceiver 208 to a remotely-located control station operated by a user. This can allow the user to guide UAV 200 over at least a portion of the aerial flight path by operation of flight controls of the remotely-located control station, with reference to real-time images displayed on a display screen of the control station. In some examples, two or more such real-time image acquisition devices may be present; one capable of scanning at least in a downward direction, and one capable of scanning at least in an upward direction. In some examples, such a real-time image acquisition device may be mounted on a gimbal or swivel mount 214 so that the device can scan upwards and downwards, and e.g. in different horizontal directions.

Any of the components mentioned above (e.g. computing device 210, wireless transceiver 208, imaging device 212) may be located at any suitable position on UAV 200, e.g., along supporting struts 206. Such components may be relatively exposed or one or more such components may be located partially or completely within a protective housing (with a portion, or all, of the housing being transparent if it is desired e.g. to use an image acquisition device that is located within the housing). In some examples, UAV 200 may include additional components such as environmental sensors and payload carriers.

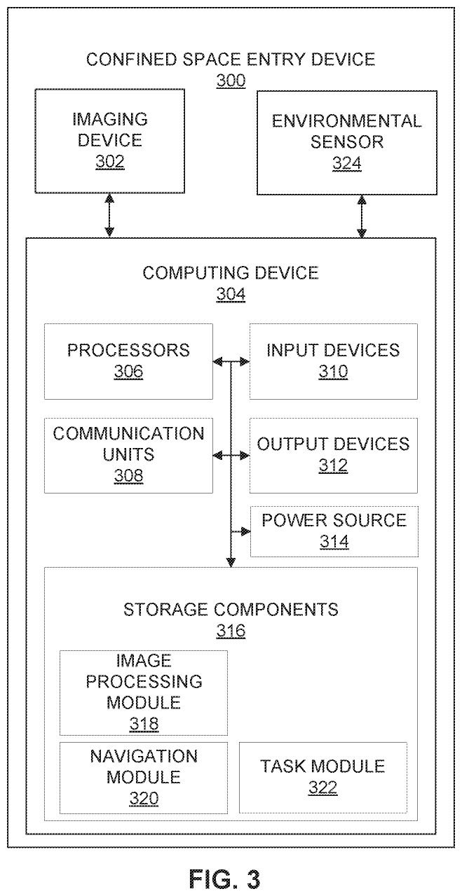

FIG. 3 is a schematic and conceptual block diagram illustrating an example confined space entry device 300 that includes an imaging device 302, a computing device 304, and an environmental sensor 324. Confined space entry device 300 of FIG. 3 is described below as an example or alternate implementation of system 100 of FIG. 1 and/or UAV 200 of FIG. 2. Other examples may be used or may be appropriate in some instances. Although confined space entry device 300 may be a stand-alone device, confined space entry device 300 may take many forms, and may be, or may be part of, any component, device, or system that includes a processor or other suitable computing environment for processing information or executing software instructions. For example, confined space entry device 30 may include a wearable device configured to be worn by a worker, such as an entrant. In some examples, confined space entry device 300, or components thereof, may be fully implemented as hardware in one or more devices or logic elements. Confined space entry device 300 may represent multiple computing servers operating as a distributed system to perform the functionality described with respect to a system 100, UAV 200, and/or confined space entry device 300.

Imaging device 302 may be the same as or substantially similar to imaging device 104 of FIG. 1 and/or imaging device 212 of FIG. 2. Imaging device 302 is communicatively coupled to computing device 304.

Environmental sensor 324 is communicatively coupled to computing device 304. Environmental sensor 324 may include any suitable environmental sensor 324 for mounting to confined space entry device 300, e.g., UAV 102 or UAV 200. For example, environmental sensor 324 may include multi-gas sensor, a thermocouple, a pressure transducer, or the like. In this way, environmental sensor 324 may be configured to detect gases (e.g., flammable gas lower explosive limit, oxygen level, hydrogen sulfide, and/or carbon monoxide), temperature, pressure, or the like to enable confined space entry device 300 to monitor and/or provide alters of environmental conditions that pose health and/or safety hazards to entrants.

Computing device 304 may include one or more processor 306, one or more communication units 308, one or more input devices 310, one or more output devices 312, power source 314, and one or more storage devices 316. One or more storage devices 316 may store image processing module 318, navigation module 320, and command module 322. One or more of the devices, modules, storage areas, or other components of confined space entry device 300 may be interconnected to enable inter-component communications (physically, communicatively, and/or operatively). In some examples, such connectivity may be provided by system bus, a network connection, an inter-process communication data structure, or any other method for communicating data.

Power source 314 may provide power to one or more components of confined space entry device 300. In some examples, power source 314 may be a battery. In some examples, power source 314 may receive power from the primary alternative current (AC) power supply. In some examples, confined space entry device 300 and/or power source 314 may receive power from another source.

One or more input devices 310 of confined space entry device 300 may generate, receive, or process input. Such input may include input from a keyboard, pointing device, voice responsive system, environmental detection system, biometric detection/response system, button, sensor, mobile device, control pad, microphone, presence-sensitive screen, network, or any other type of device for detecting input from a human or a machine. One or more output devices 312 of confined space entry device 300 may generate, transmit, or process output. Examples of output are tactile, audio, visual, and/or video output. Output devices 312 may include a display, sound card, video graphics adapter card, speaker, presence-sensitive screen, one or more USB interfaces, video and/or audio output interfaces, or any other type of device capable of generating tactile, audio, video, or other output. Output devices 312 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of device for generating tactile, audio, and/or visual output. In some examples, confined space entry device 300 may include a presence-sensitive display that may serve as a user interface device that operates both as one or more input devices 310 and one or more output devices 312.

One or more communication units 308 of computing device 304 may communicate with devices external to confined space entry device 300 by transmitting and/or receiving data, and may operate, in some respects, as both an input device and an output device. In some examples, communication units 308 may communicate with other devices over a network, e.g., imaging device 302, external computing devices, hubs, and/or remotely-located control stations. In other examples, one or more communication units 308 may send and/or receive radio signals on a radio network such as a cellular radio network. In other examples, one or more communication units 308 may transmit and/or receive satellite signals on a satellite network such as a Global Positioning System (GPS) network. Examples of one or more communication units 308 may include a network interface card (e.g. such as an Ethernet card), an optical transceiver, a radio frequency transceiver, a GPS receiver, or any other type of device that can send and/or receive information. Other examples of one or more communication units 308 may include Bluetooth®, GPS, 3G, 4G, and Wi-Fi® radios found in mobile devices as well as Universal Serial Bus (USB) controllers and the like.

One or more processor 306 of confined space entry device 300 may implement functionality and/or execute instructions associated with confined space entry device 300. Examples of one or more processor 306 may include microprocessors, application processors, display controllers, auxiliary processors, one or more sensor hubs, and any other hardware configured to function as a processor, a processing unit, or a processing device. Confined space entry device 300 may use one or more processor 306 to perform operations in accordance with one or more aspects of the present disclosure using software, hardware, firmware, or a mixture of hardware, software, and firmware residing in and/or executing at confined space entry device 300.

One or more storage devices 316 within computing device 304 may store information for processing during operation of confined space entry device 300. In some examples, one or more storage devices 316 are temporary memories, meaning that a primary purpose of the one or more storage devices is not long-term storage. One or more storage devices 316 within computing device 304 may be configured for short-term storage of information as volatile memory and therefore not retain stored contents if deactivated. Examples of volatile memories may include random access memories (RAM), dynamic random-access memories (DRAM), static random-access memories (SRAM), and other forms of volatile memories known in the art. One or more storage devices 316, in some examples, also include one or more computer-readable storage media. One or more storage devices 316 may be configured to store larger amounts of information than volatile memory. One or more storage devices 316 may further be configured for long-term storage of information as non-volatile memory space and retain information after activate/off cycles. Examples of non-volatile memories may include magnetic hard disks, optical discs, floppy disks, flash memories, or forms of electrically programmable memories (EPROM) or electrically erasable and programmable (EEPROM) memories. One or more storage devices 316 may store program instructions and/or data associated with one or more of the modules described in accordance with one or more aspects of this disclosure.

One or more processor 306 and one or more storage devices 316 may provide an operating environment or platform for one or more modules, which may be implemented as software, but may in some examples include any combination of hardware, firmware, and software. One or more processor 306 may execute instructions and one or more storage devices 316 may store instructions and/or data of one or more modules. The combination of one or more processor 306 and one or more storage devices 316 may retrieve, store, and/or execute the instructions and/or data of one or more applications, modules, or software. One or more processor 306 and/or one or more storage devices 316 may also be operably coupled to one or more other software and/or hardware components, including, but not limited to, one or more of the components illustrated in FIG. 3.

One or more modules illustrated in FIG. 3 as being included within one or more storage devices 316 (or modules otherwise described herein) may perform operations described using software, hardware, firmware, or a mixture of hardware, software, and firmware residing in and/or executing at computing device 304. Computing device 304 may execute each of the module(s) with multiple processors or multiple devices. Computing device 304 may execute one or more of such modules as a virtual machine or container executing on underlying hardware. One or more of such modules may execute as one or more services of an operating system or computing platform. One or more of such modules may execute as one or more executable programs at an application layer of a computing platform.

One or more storage devices 316 stores image processing module 318. In some examples, image processing module 318 includes a data structure that maps optical pattern codes on a location marking label having the optical pattern codes embodied thereon to a unique identifier and/or location information. In some examples, image processing module 318 may include an associative data structure (e.g., a repository) including a model that includes locations of each respective location marking label within a confined space. Image processing module 318 may use the model to map a unique identifier to a location within a confined space.

One or more storage devices 316 stores navigation module 320. Navigation module 320 may include a list of rules defining possible paths of travel and/or maneuvers within a confined space. For example, navigation module 320 may use a database, a list, a file, or other structure to map optical pattern codes on a location marking label to distance vector and/or trajectory information defining a path of travel between one or more location marking labels and/or a maneuver to be performed at or near the location marking label (e.g., landing in a predetermined location). Additionally, or alternatively, navigation module 320 may use data embodied on a respective location marking label to determine distance vector and/or trajectory information defining a path of travel between the respective location marking label and one or more different location marking labels. In examples in which confined space entry device 300 includes a wearable device, navigation module 320 may output, e.g., via output devices 312, a navigational message that includes one or more of an audible message and a visual message. By associating paths of travel with a respective location marking label, navigation module 320 may enable confined space entry device to determine, and optionally execute, navigation through a confined space.

One or more storage devices 316 stores command module 322. Command module 322 may include a list of commands defining possible operations to be performed by confined space entry device 300. For example, command module 322 may use a database, a list, a file, or other structure to map optical pattern codes on a location marking label to data defining an operation to be performed by confined space entry device 300 at or near a location marking label. Additionally, or alternatively, command module 322 may use data embodied on a respective location marking label to determine distance vector and/or trajectory information defining a path of travel to a location where an operation is to be performed by confined space entry device 300. Example task include, but are not limited to, sampling (e.g., sampling gases, temperature, or the like in the local environment, or retrieving a product sample), performing a maneuver (e.g., landing in a predetermined location), imaging (e.g., an area within the confined space), cleaning (e.g., cleaning a component such as a sensor within the confined space), performing work (e.g., repairing a component such as a sensor within the confined space), or retrieving data from a remote server. By associating one or more tasks with a respective location marking label, command module 322 may enable confined space entry device 300 to conserve resources such as, for example, battery, processing power, sampling capability, or the like.

In some examples, confined space entry device 300 may include a user interface module for display of processor 306 outputs via output devices 312 or to enable an operator to configure image processing module 318, navigation module 320, and/or command module 322. In some examples, output devices 312 receives from navigation module 320, via processor 306, audio, visual, or tactile instructions understandable by a human or machine to navigate through a confined space. In some examples, input devices 310 may receive user input including configuration data for image processing module 318, e.g., optical patterns associated with a respective location marking label, navigation module 320, e.g., a module including locations of each location marking label within a confined space, and command module 322, e.g., possible task to be performed at each respective location marking label. The user interface module may process the configuration data and update the image processing module 318, navigation module 320, and/or command module 322 using the configuration data.

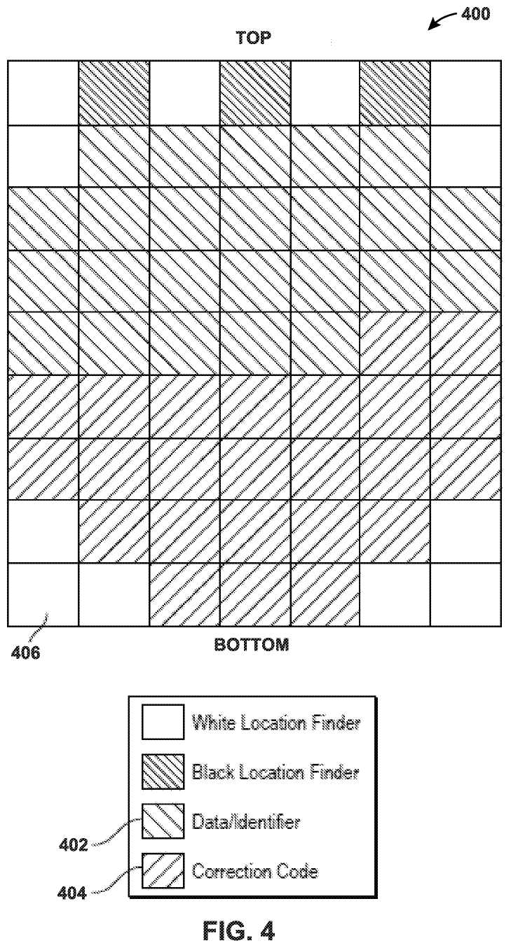

FIG. 4 is a schematic and conceptual diagram illustrating an example location marking label 400 including decodable data for embodiment within a confined space. Location marking label 400 is a visual representation of an optical pattern code. Location marking label 400 in this example is 7 modules (width) by 9 modules (height), but in other examples may be expanded or reduced in dimension. Each module or “cell” 406 is colored either white or black (light reflecting or absorbing, respectively). A pre-defined set of modules 406 (labelled in FIG. 4 as “white location finder” and “black location finder”) are always either white or black according to a pre-defined pattern, which allows the image processing software of system 100 to locate and identify that an optical pattern code is present in an image generated by an imaging device. In FIG. 4, white location finders are located at the corners and “top” of location marking label 400 and the black location finders are located at the “top” of location marking label 400. In addition, the set of modules 406 that make up the white and black location finders allow the image processing software to determine an orientation of the location marking label 400 with respect to the coordinate system of the image. In FIG. 4, the “top” of location marking label 400 is labeled “TOP” and the “bottom” is labeled “BOTTOM” to denote that location marking label 400 has an orientation. The remaining 48 cells are divided into 24 data cells 402 that gives unique representations based on the black/white assignments for each cell as well as 24 correction code cells 404 that allows the code to be recovered even if the code is partially blocked or incorrectly read. In this specific design, there are 2\hat{ }24 unique representations (˜16 million), but based on the resolution needed, the code can be expanded to include more data cells 402 and fewer correction code cells 404 (for example, if 12 of the correction code cells 404 become data cells 402, there would be 2\hat{ }36 or ˜64 billion unique representations). In some examples, two or more cells, such as four cells, may include a first resolution and a second resolution. For example, four cells may be viewable at a first (lower) resolution and a second (higher) resolution such that a single cell is viewed at the first (lower) resolution and four cells are viewed at the second (higher) resolution. In this way, the data cells 402 may provide multiple data sets dependent on resolution of the image of the data cells 402.

In some cases, the code operates as a more generalized version of the code where a full rectangular retroreflective substrate is available, and the correction code is left fully intact for recovery and verification. The location finder uses all corners of the code and an alternating white/black pattern along the top edge allows for a single system to differentiate and decode multiple code sizes.

In some examples, location marking label 400 is printed onto 3M High Definition License Plate Sheeting Series 6700 with a black ink using an ultraviolet (UV) inkjet printer, such as MIMAKI UJF-3042HG or 3M™ Precision Plate System to produce an optical tag. The ink may contain carbon black as the pigment and be infrared absorptive (i.e., appears black when viewed by an infrared camera). The sheeting may include a pressure-sensitive adhesive layer that allows the printed tag to be laminated onto surfaces within a confined space. In some examples, the location marking label 400 is visible to the user. In some examples, an additional layer of mirror film can be laminated over the sheeting with the printed location marking label 400, thereby hiding the printed location marking label 400 from the unaided eye. As the mirror film is transparent to infrared light, an infrared camera can still detect the location marking label 400 behind the mirror film, which may also improve image processing precision. The mirror film can also be printed with an ink that is infrared transparent without interfering with the ability for an infrared camera to detect the location marking label 400. In some examples, location marking label 400 may include one or more additional protective layers, such as, for example, a protective film configured to resist deterioration in environments within a confined space (e.g., temperature or chemical resistance protective films).

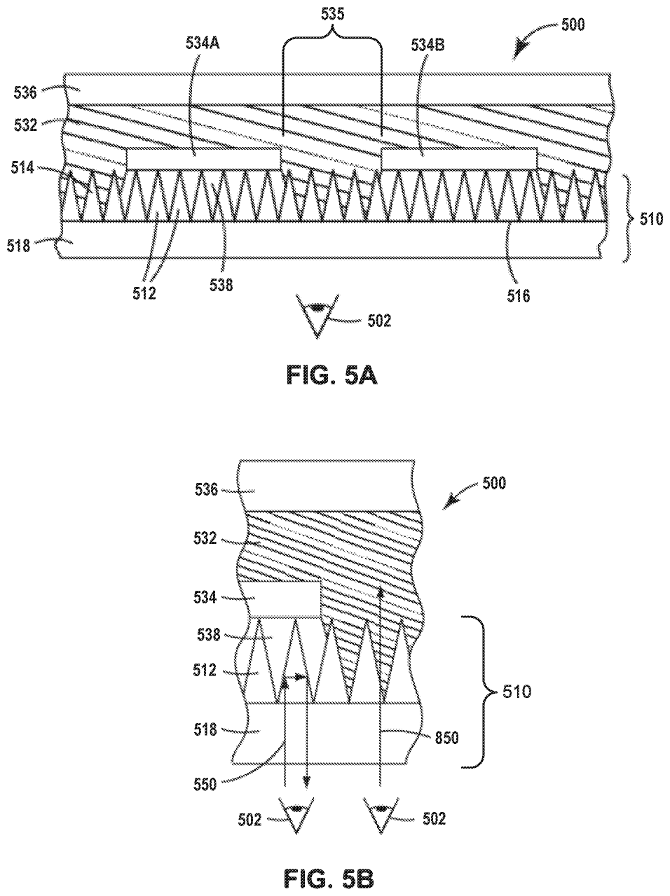

In some examples, location marking label 400 may be generated to include one or more layers that avoid the high reflectivity of a mirror film but be infrared transparent such that the machine-readable code is not visible in ambient light but readily detectable within images obtained by an infrared camera. This construction may be less distracting to workers or other users. For example, location marking label 400 may include a white mirror film, such as those disclosed in PCT/US2017/014031, incorporated herein by reference in its entirety, on top of a retroreflective material. The radiometric properties of the retroreflective light of a location marking label may be measured with an Ocean Optics Spectrometer (model number FLAME-S-VIS-NIR), light source (model HL-2000-FHSA), and reflectance probe (model QR400-7-VIS-BX) over a geometry of 0.2-degree observation angle and 0-degree entrance angle, as shown by percent of reflectivity (R%) over a wavelength range of 400-1000 nanometers. FIGS. 5A and 5B are schematic and conceptual diagrams illustrating cross-sectional views of portions of an example location marking label formed on a retroreflective sheet. Retroreflective article 500 includes a retroreflective layer 510 including multiple cube corner elements 512 that collectively form a structured surface 514 opposite a major surface 516. The optical elements can be full cubes, truncated cubes, or preferred geometry (PG) cubes as described in, for example, U.S. Pat. No. 7,422,334, incorporated herein by reference in its entirety. The specific retroreflective layer 510 shown in FIGS. 5A-5B includes a body layer 518, but those of skill will appreciate that some examples do not include an overlay layer. One or more barrier layers 534 are positioned between retroreflective layer 510 and conforming layer 532, creating a low refractive index area 538. Barrier layers 534 form a physical “barrier” between cube corner elements 512 and conforming layer 532. Barrier layer 534 can directly contact or be spaced apart from or can push slightly into the tips of cube corner elements 512. Barrier layers 534 have a characteristic that varies from a characteristic in one of (1) the areas not including barrier layers (view line of light ray 550) or (2) another barrier layer 534. Exemplary characteristics include, for example, color and infrared absorbency.

In general, any material that prevents the conforming layer material from contacting cube corner elements 512 or flowing or creeping into low refractive index area 538 can be used to form the barrier layer. Exemplary materials for use in barrier layer 534 include resins, polymeric materials, dyes, inks (including color-shifting inks), vinyl, inorganic materials, UV-curable polymers, multi-layer optical films (including, for example, color-shifting multi-layer optical films), pigments, particles, and beads. The size and spacing of the one or more barrier layers 534 can be varied. In some examples, one or more barrier layers 534 may form a pattern on the retroreflective sheet. In some examples, one may wish to reduce the visibility of the pattern on the sheeting. In general, any desired pattern can be generated by combinations of the described techniques, including, for example, indicia such as letters, words, alphanumerics, symbols, graphics, logos, or pictures. The patterns can also be continuous, discontinuous, monotonic, dotted, serpentine, any smoothly varying function, stripes, varying in the machine direction, the transverse direction, or both; the pattern can form an image, logo, or text, and the pattern can include patterned coatings and/or perforations. The pattern can include, for example, an irregular pattern, a regular pattern, a grid, words, graphics, images, lines, and intersecting zones that form cells.

The low refractive index area 538 is positioned between (1) one or both of barrier layer 534 and conforming layer 532 and (2) cube corner elements 512. The low refractive index area 538 facilitates total internal reflection such that light that is incident on cube corner elements 512 adjacent to a low refractive index area 538 is retroreflected. As is shown in FIG. 5B, a light ray 550 incident on a cube corner element 512 that is adjacent to low refractive index layer 538 is retroreflected back to viewer 502. For this reason, an area of retroreflective article 500 that includes low refractive index layer 538 can be referred to as an optically active area. In contrast, an area of retroreflective article 500 that does not include low refractive index layer 538 can be referred to as an optically inactive area because it does not substantially retroreflect incident light. As used herein, the term “optically inactive area” refers to an area that is at least 50% less optically active (e.g., retroreflective) than an optically active area. In some examples, the optically inactive area is at least 40% less optically active, or at least 30% less optically active, or at least 20% less optically active, or at least 10% less optically active, or at least at least 5% less optically active than an optically active area.

Low refractive index layer 538 includes a material that has a refractive index that is less than about 1.30, less than about 1.25, less than about 1.2, less than about 1.15, less than about 1.10, or less than about 1.05. In general, any material that prevents the conforming layer material from contacting cube corner elements 512 or flowing or creeping into low refractive index area 538 can be used as the low refractive index material. In some examples, barrier layer 534 has sufficient structural integrity to prevent conforming layer 532 from flowing into a low refractive index area 538. In such examples, low refractive index area may include, for example, a gas (e.g., air, nitrogen, argon, and the like). In other examples, low refractive index area includes a solid or liquid substance that can flow into or be pressed into or onto cube corner elements 512. Example materials include, for example, ultra-low index coatings (those described in PCT Patent Application No. PCT/US2010/031290), and gels.

The portions of conforming layer 532 that are adjacent to or in contact with cube corner elements 512 form non-optically active (e.g., non-retroreflective) areas or cells. In some examples, conforming layer 532 is optically opaque. In some examples conforming layer 532 has a white color.

In some examples, conforming layer 532 is an adhesive. Example adhesives include those described in PCT Patent Application No. PCT/US2010/031290. Where the conforming layer is an adhesive, the conforming layer may assist in holding the entire retroreflective construction together and/or the viscoelastic nature of barrier layers 534 may prevent wetting of cube tips or surfaces either initially during fabrication of the retroreflective article or over time.

In the example of FIG. 5A, a non-barrier region 535 does not include a barrier layer, such as barrier layer 534. As such, light may reflect with a lower intensity than barrier layers 534A and 534B. Different patterns of non-barrier regions 535 and barrier layers 534A and 534B on different instances of retroreflective article 500 may define the optical patterns described and used herein.

Additional example implementations of a retroreflective article for embodying an optical pattern are described in U.S. patent application Ser. No. 14/388,082, filed Mar. 29, 2013, which is incorporated by reference herein in its entirety. Additional description is found in U.S. Provisional Appl. No. 62/400,865, filed Sep. 28, 2016; 62/485,449, filed Apr. 14, 2017; 62/400,874, filed Sept. 28, 2016; 62/485,426, filed Apr. 14, 2017; 62/400,879, filed Sep. 28, 2016; 62/485,471, filed Apr. 14, 2017; and 62/461,177, filed Feb. 20, 2017; each of which is incorporated herein by reference in its entirety.

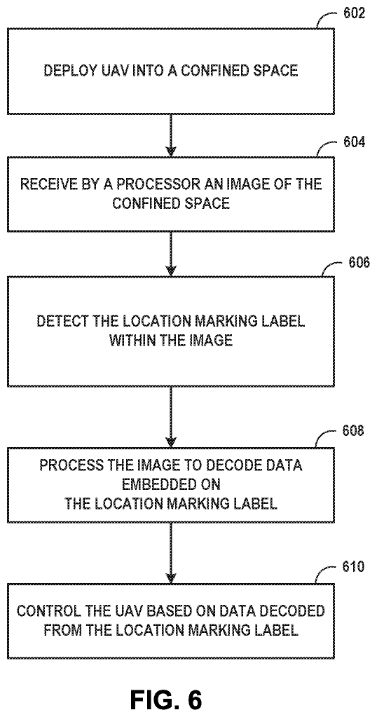

FIG. 6 is a flowchart illustrating an example of controlling a UAV based on data decoded from a location marking label. The technique of FIG. 6 will be described with reference to system 100 of FIG. 1, although a person of ordinary skill in the art will appreciate that similar techniques may be used to control a UAV, such as UAV 200 of FIG. 2, or a confined space entry device, such as confined space entry device 300 of FIG. 3. Additionally, a person of ordinary skill in the art will appreciate that system 100 of FIG. 1, UAV 200 of FIG. 2, and confined space entry device 300 of FIG. 3 may be used with different techniques.

The technique of FIG. 6 includes introducing UAV 102 having imaging device 104 and computing device 103 mounted thereon into confined space 106 (602). For example, as discussed above with respect to FIG. 1, UAV 102 is configured to fit within confined space 106, such as through manholes 108 and 110. In some examples, introducing UAV 102 into confined space 106 may include deploying UAV 102 in confined space 106 in response to an entry-required rescue situation.

The technique of FIG. 6 also includes receiving, by computing device 103 communicatively coupled to imaging device 104, an image of the interior 120 of confined space 106 (604). The image may include at least one respective location marking label of location marking labels 122. In some examples, receiving the image may include receiving a plurality of images of location marking labels. In some examples, receiving the image may include receiving an image of a respective location marking label of location marking labels 122 in confined space 106 and an image of a disabled entrant.

The technique of FIG. 6 also includes detecting, by computing device 103, e.g., processor 306, a respective location marking label of location marking labels 122 within the received image (606). In some examples, detecting a respective location marking label of locating marking labels 122 may include detecting a disabled entrant.

The technique of FIG. 6 also includes processing, by computing device 103, e.g., processor 306, the image to decode data embedded on the respective location marking label of location marking labels 122 (608). The data may include a location of the respective locating marking label of location marking labels 122 within confined space 106. For example, the data may include a unique identifier to enable by computing device 103, e.g., processor 306, to determine, based on mapping the unique identifier to a model stored in a repository, a location of the respective location marking label. As another example, the data may include data indicative of the position of UAV 102 within confined space 106, e.g., a distance of UAV 102 from the location marking label 122 and/or an orientation of UAV 102 relative to the location making label 122. Alternatively, or additionally, the data may include a command readable by computing device 103, e.g., processor 306. Example commands may include causing system 100 to collect a sample (e.g., sampling an environmental condition such as gases, temperature, pressure or the like, or retrieving a product sample), perform a maneuver (e.g., landing in a predetermined location), image an area within the confined space, clean a component such as a sensor within the confined space, performing work (e.g., repairing a component such as a sensor within the confined space), or retrieve data from a remote server. By processing the image to decode data embedded on the respective location marking label of location marking labels 122, system 100 may conserve resources such as, for example, battery, processing power, sampling capability, or the like.

In some examples, processing the image to decode data may include processing, by computing device 103, e.g., processor 306, a plurality of resolutions of the image. For example, a first resolution of the image may include a first data set and a second resolution of the image may include a second data. The first (e.g., lower) resolution of a respective image may include decodable data indicative of a unique identifier of the respective location marking label of location marking labels. The second (e.g., higher) resolution of the respective image may include decodable data indicative of the position of UAV 102 within confined space 106.

In some examples, as discussed above, processing may include determining, by the processor, an anomaly in the confined space based on the data decoded from the (first) location marking label of location marking labels 122 and the data decoded from the second location marking label of location marking labels 122.

The technique of FIG. 6 also includes controlling, by computing device 103, e.g., processor 306, navigation of UAV 102 within confined space 106 based on the data decoded from the respective location marking label of location marking labels 122 (610). In some examples, controlling navigation of UAV 102 includes determining, by computing device 103, e.g., processor 306, a location of UAV 102 in confined space 106 based on the data decoded from the respective location marking label of location marking labels 122, and controlling, by computing device 103, e.g., processor 306, navigation of UAV 102 within confined space 106 based on the location of UAV 102. For example, the data decoded from the respective location marking label of location marking labels 122 may include positional information such as distance vectors and trajectories from surfaces of interior space 120 of confined space 106 and/or other location marking labels of location marking labels 122. In some examples, the data decoded from the location marking label includes identification data (e.g., an identifier unique to the respective location marking label of location marking labels 122), and the technique may further include determining, by computing device 103, e.g., processor 306, communicatively coupled to a repository storing a model of the confined space including a location of the location marking label within the confined space (e.g., navigation module 320), a location of UAV 102 in confined space 106 based on the identification data and the model, and controlling, by computing device 103, e.g., processor 306, navigation of UAV 102 within confined space 106 based on the location of UAV 102.

In some examples, the technique optionally includes determining, by computing device 103, e.g., processor 306, a landing location for UAV 102 based on the data decoded from the location marking label 122. For example, the data decoded from the location marking label 122 may include a landing location. The landing location may be remote from the location of the location marking label 122.

In some examples, the technique optionally includes controlling, by computing device 103, e.g., processor 306, communicatively coupled to environmental sensor 324 mounted on UAV 102, environmental sensor 324 to collect local environment information. For example, environmental sensor 324 may be configured to detect gases (e.g., flammable gas lower explosive limit, oxygen level, hydrogen sulfide, and/or carbon monoxide), temperature, pressure, or the like. By controlling environmental sensor 324 to collect location environmental information, the technique of FIG. 6 may include determining whether confined space 106 includes conditions that may be hazardous to entrants.

In some examples, the technique of optionally includes repeating capturing, by imaging device 104, an image; receiving, by computing device 103, e.g., processor 306, the image; processing, by computing device 103, e.g., processor 306, the image; and controlling, by computing device 103, e.g., processor 306, UAV 102. For example, the technique may include capturing, by imaging device 104, a second image of images 126 of a second location marking label of location marking labels 122 in confined space 106. The technique also may include receiving, by computing device 103, e.g., processor 306, the second image of images 126 of the second location marking label of location marking labels 122. The technique also may include processing, by computing device 103, e.g., processor 306, the second image of images 126 to decode data embedded within the second location marking label of location marking labels 122. The technique also may include controlling, by computing device 103, e.g., processor 306, UAV 102 based on the data decoded from the second location marking label of location marking labels 122. In some examples, as discussed above, processing may include determining, by computing device 103, e.g., processor 306, a position and/or an orientation of UAV 102 within confined space 106 based on the data decoded from the (first) location marking label of location marking labels 122 and the data decoded from the second location marking label of location marking labels 122. In this way, the technique may include using a plurality of images of a plurality of location marking labels to control navigation or an operation of a confined space entry device.

Various examples have been described. These and other examples are within the scope of the following claims.

1. A system comprising:
an unmanned aerial vehicle (UAV), wherein the UAV includes an imaging device; and
a processor communicatively coupled to the imaging device, wherein the processor is configured to:
receive, from the imaging device, an image of a defined region of a work environment;
detect a location marking label within the image;
process the image to decode data embedded on the location marking label; and
control navigation of the UAV within the defined region of the work environment based on the data decoded from the location marking label.

2. The system of claim 1, wherein the defined region of the work environment comprises a confined space.

3. The system of claim 2, wherein the location marking label comprises a retroreflective material layer with at least one optical pattern embodied thereon.

4. The system of claim 3, wherein the location marking label further comprises:
a mirror film layer on the retroreflective material layer; and
an adhesive layer adhering the location marking label to a surface of the confined space.

5. The system of claim 1, wherein the processor is further configured to:
determine a location of the UAV in the confined space based on the data decoded from the location marking label; and
control navigation of the UAV within the confined space based on the location of the UAV.

6. The system of claim 1, wherein the data decoded from the location marking label comprises identification data, wherein the processor is communicatively coupled to a repository storing a model of the confined space, wherein the model includes a location of the location marking label within the confined space, and wherein the processor is further configured to:
determine a location of the UAV in the confined space based on the identification data and the model; and
control navigation of the UAV within the confined space based on the location of the UAV.

7. The system of claim 1, wherein the data decoded from the location marking label comprises a distance vector and a trajectory to a second location marking label, and wherein the processor is further configured to control navigation of the UAV toward the second location marking label.

8. The system of claim 1, further comprising an environmental sensor communicatively coupled to the processor, wherein the environmental sensor is mounted to the UAV, wherein the processor is further configured to control the environmental sensor to collect local environment information in the confined space.

9. The system of claim 1, wherein processing the image to decode data embedded on the location marking label includes:
processing a first resolution of the image of the confined space to decode a first data set embedded on a first location marking label; and
processing a second resolution of the image of the confined space to decode a second data set embedded on the first location marking label.

10. The system of claim 1, wherein the processor is configured to:
receive from the imaging device a second image of the confined space;
detect a second location marking label within the second image of the confined space;
process the second image to decode data embedded within the second location marking label; and
control the UAV based on the data decoded from the second location marking label.

11. The system of claim 10, wherein the processor is further configured to determine an orientation of the UAV based on the data decoded from the location marking label and the data decoded from the second location marking label.

12. The system of claim 10, wherein the processor is further configured to determine an anomaly in the confined space based on the data decoded from the location marking label and the data decoded from the second location marking label.

13. The system of claim 1, wherein the processor is further configured to determine a landing location for the UAV based on the data decoded from the location marking label.

14. The system of claim 13, wherein the data decoded from the location marking label comprises the landing location.

15. The system of claim 13, wherein the landing location is remote from the location of the location marking label.

16. The system of claim 1, wherein the processor is further configured to determine a distance of the UAV from the location marking label based on the data decoded from the location marking label.

17. A system comprising:
a confined space entry device comprising an imaging device;
a processor communicatively coupled to the imaging device, wherein the processor is configured to:
receive, from the imaging device, an image of a confined space;
detect a location marking label within the image;
process the image to decode data embedded within the location marking label; and
control navigation of the confined space entry device within the confined space based on the data decoded from the location marking label.

18. The system of claim 17,
wherein the confined space entry device is a wearable device; and
wherein controlling navigation of the confined space entry device comprises outputting a navigational message by the wearable device, the navigational message comprising one or more of an audible message and a visual message.

19. The system of claim 17, wherein the confined space entry device further comprises an unmanned aerial vehicle.

20. A method comprising:
deploying, into a confined space, an unmanned aerial vehicle (UAV), the UAV including an imaging device;
receiving, by a processor communicatively coupled to the imaging device, an image of the confined space captured by the imaging device;
detecting a location marking label within the image;
processing, by the processor, the image to decode data embedded on the location marking label; and
controlling, by the processor, navigation of the UAV within the confined space based on the data decoded from the location marking label.

21-33. (canceled)
